(19) United States
(12) Patent Application Publication
(10) Pub. No.: US 2010/0188562 A1
(43) Pub. Date: Jul. 29, 2010

(54) Visual presenter

(75) Inventors: Hiroshi Yamakose, Gifu (JP); Shinji Ono, Aichi (JP); Kenichi Maruyama, Aichi (JP)

Correspondence Address: POSZ LAW GROUP, PLC, 12040 SOUTH LAKES DRIVE, SUITE 101, RESTON, VA, 20191, US

(73) Assignee: Elmo Co., Ltd., Nagoya-shi (JP)

(21) Appl. No.: 12/588,140

(22) Filed: Oct. 6, 2009

(30) Foreign Application Priority Data
Jan. 27, 2009 (JP) 2009-014845

(51) Int. Cl. H04N 5/225

(52) U.S. Cl. 348/373; 348/E05.024

(57) ABSTRACT

A visual presenter includes a base, a column support standing on the base and having a distal end, the column support including an upright part standing upright from the base and a horizontal part that is continuous from the upright part and extends horizontally ahead of the base, the camera head being adapted to image a material placed on an installation surface for the presenter, and a plurality of legs which are mounted on an underside of the base so that one of the legs is located at a predetermined position spaced backward from a front of the base by a predetermined distance. The legs extend in a direction perpendicular to the underside of the base so that an imaging area of the camera head on the installation surface is enlarged so as to cover an area immediately before an installation point of the leg.

### CROSS-REFERENCE TO RELATED APPLICATIONS

This application is based on and claims the benefit of priority from the prior Japanese Patent Application No. 2009-14845, filed on Jan. 27, 2009, the entire contents of which are incorporated herein by reference.

### BACKGROUND

1. Field

The present invention relates to a visual presenter in which a camera head is provided on a distal end of a column support standing on a base, and a material such as document or model placed in front of the base is imaged by the camera head, and an obtained image is reproduced by a monitor television or projected on a screen by a video projector.

2. Related Art

Japanese patent application publication, JP-2008-193391 discloses one type of visual presenter. FIGS. 8 and 9 show the disclosed visual presenter 100. As shown, a support column 102 is mounted on a base 101 so as to stand from the base 101. The support column 102 has a distal end on which a camera head 103 is mounted.

The support column 102 of the visual presenter 100 includes an upright part 102a standing upright from the base 101 and a horizontal part 102b that is continuous from the upright part 102a and extends horizontally ahead of the base 101. The camera head 103 is mounted on the distal end of the horizontal part 102b. A material such as document is placed on an installation surface on which the visual presenter is placed, so as to come close to a front of the base 101 and is imaged by an imaging lens 104 of the camera head 103.

In the above-described visual presenter 100, a mounting 200 discrete from the visual presenter 100 is used when a material has a larger size than an imaging area of the camera head 103. In this case, the visual presenter 100 is placed on the mounting 200, and the material is then imaged by the camera head 103. An object distance from the imaging lens 104 of the camera head 103 to the material becomes longer when the mounting 200 is used than when the mounting 200 is not used. Accordingly, the imaging area 201 of the camera head 103 can be enlarged.

In the conventional visual presenter 100, however, the imaging area cannot be enlarged without use of the mounting 200 which is discrete from the visual presenter 100 and on which the visual presenter 100 needs to be placed. Thus, the conventional visual presenter 100 is not convenient for users.

Furthermore, when the visual presenter 100 is placed on the mounting 200 so that the imaging area 201 is enlarged, even a front end of the mounting 200 is included in the imaging area 201 as shown in FIG. 9, whereupon the front end of the mounting 200 is imaged by the camera head 103 together with the material. This poses a problem.

### SUMMARY

Therefore, an object of the present invention is to provide a visual presenter which can enlarge the imaging area without use of the mounting by a simple operation and has good usability.

Another object of the invention is to provide a visual presenter which can image only the material when the imaging area is enlarged, preventing anything other than the material from being imaged together with the material.

According to one aspect of the present invention, there is provided a visual presenter comprising a base; a column support standing on the base and having a distal end on which a camera head is located, the column support including an upright part standing upright from the base and a horizontal part that is continuous from the upright part and extends horizontally ahead of the base, the distal end of the column support corresponding to a distal end of the horizontal part, the camera head being mounted on the distal end of the horizontal part and adapted to image a material placed on an installation surface for the presenter; and a plurality of legs which are mounted on an underside of the base so that one of the legs is located at a predetermined position spaced backward from a front of the base by a predetermined distance, the legs extending in a direction perpendicular to the underside of the base so that an imaging area of the camera head on the installation surface is enlarged so as to cover an area immediately before an installation point of said one leg.

In the above-described construction, the legs are mounted on the underside of the base so as to extend in the direction perpendicular to the underside of the base. Accordingly, the distance from the camera head to the material placed on the mounting surface for the presenter is increased by a height of each leg as compared with the case where the base is directly placed on the installation surface. Consequently, the imaging area of the camera head can be increased, whereupon a material with a larger size can be imaged.

Furthermore, one of the legs extends in the direction perpendicular to the underside of the base so that one of the legs is located at a predetermined position spaced backward from a front of the base by a predetermined distance. Consequently, even when the material to be imaged has a larger size, the leg can be prevented from being imaged together with the material.

In an embodiment, each leg is pivotable between a raised state where the leg hangs down from the underside of the base and a laid state where the leg is laid on the underside of the base.

In another embodiment, the underside of the base has a plurality of storage recesses in which the legs are stored in the laid state respectively.

### BRIEF DESCRIPTION OF THE DRAWINGS

FIG. 1 is a perspective view of a visual presenter in accordance with one embodiment of the present invention;

FIG. 2 is a perspective view of the visual presenter as viewed at the underside thereof;

FIG. 3 is a perspective view of the visual presenter with a leg having been laid down on the underside thereof;

FIG. 4 is a side view of the visual presenter with the leg having been laid down on the underside thereof;

FIG. 5 is a plan view of the visual presenter with the leg having been laid down on the underside thereof;

FIG. 6 is a side view of the visual presenter with the leg standing upright;

FIG. 7 is a plan view of the visual presenter with the leg standing upright;

FIG. 8 is a perspective view of a conventional visual presenter; and

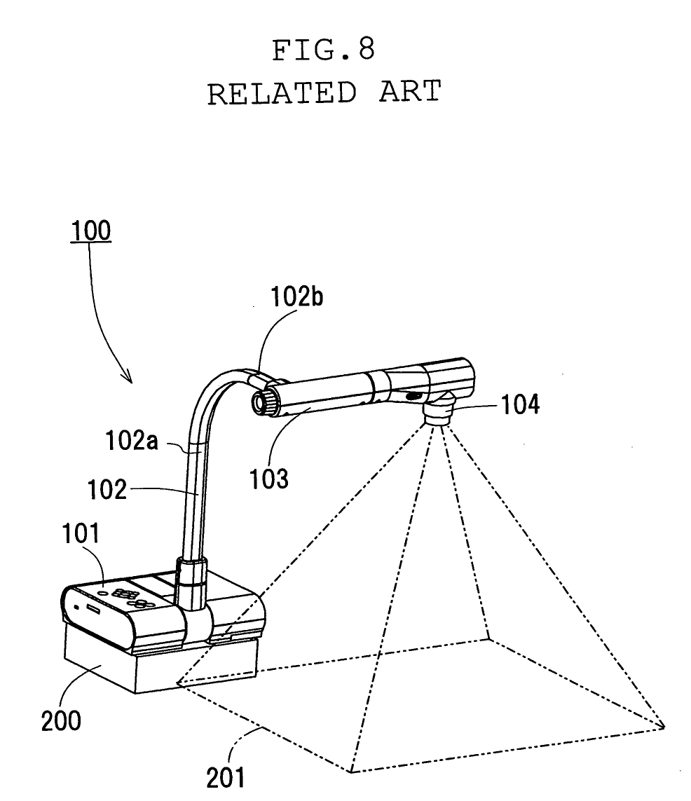

FIG. 9 is a side view of the conventional visual presenter.

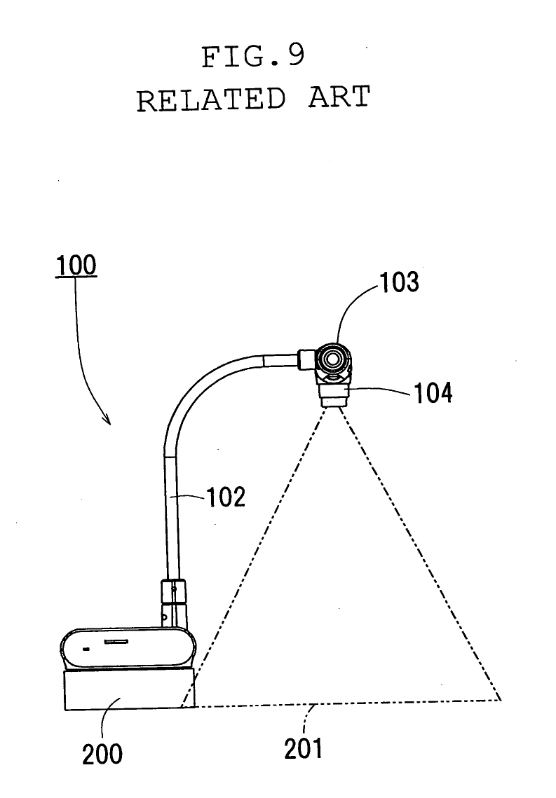

### DETAILED DESCRIPTION

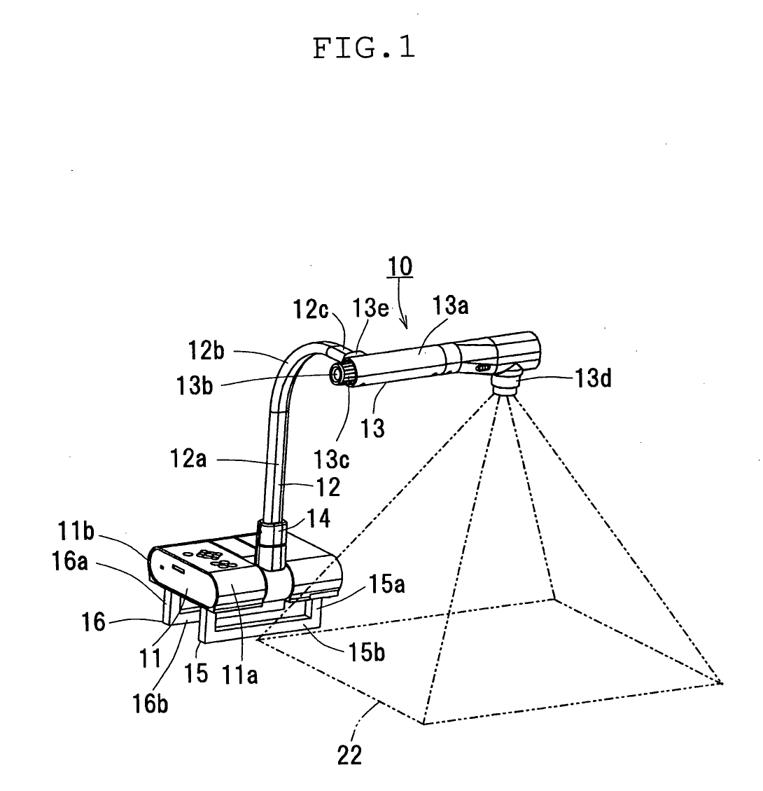

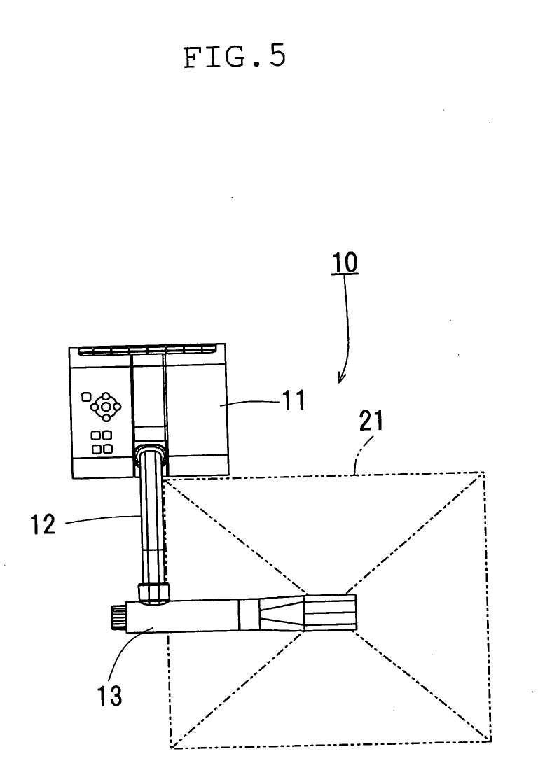

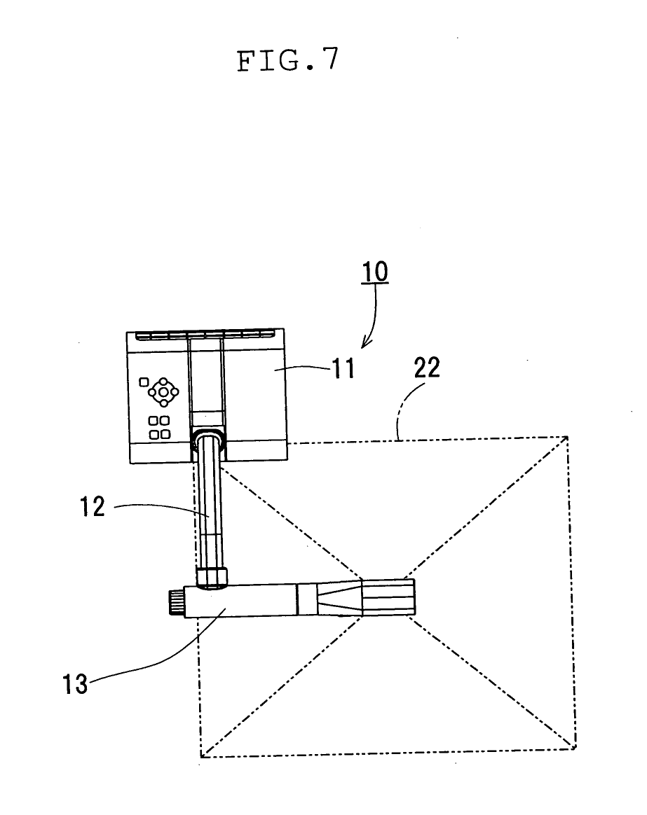

One embodiment of the present invention will be described with reference to FIGS. 1 to 7 of the accompanying drawings. Referring to FIG. 1, a visual presenter of the embodiment is shown. The visual presenter 1 includes a base 11, a support column 12 and a camera head 13. The base 11 is rectangular in planar shape and includes a front 11a and a rear 11b both of which are curved or more specifically, bulged outward. A control circuit unit (not shown) is incorporated in the base 11. The rear 11b of the base 11 is provided with terminals which are used to connect the visual presenter to a TV monitor, a video projector 10 and the like.

The support column 12 has a hollow construction and is mounted on a support bracket 14 so as to stand on the central front of the base 11. The support column 12 includes an upright part 12a, a curved part 12b continuous from the upright part 12a and a horizontal part 12c horizontally extending ahead of the front of the base 11 from the curved part 12b. Wire harnesses (not shown) are inserted through the support column 12 to connect between the control circuit unit incorporated in the base 11 and the camera head 13.

The camera head 13 is mounted on the distal end of the horizontal part 12c of the support column 12 and has an elongated cylindrical housing 13a having two ends. A zoom dial 13c is assembled to one end of the housing 13a of the camera head 13. An autofocus button 13b is built into the zoom dial 13c. A lens tube 13d into which an imaging lens group is built is mounted on a lower side of the other end of the camera head housing 13a. A camera control circuit (not shown) is incorporated in the housing 13a. A bracket 13e is fixed to a rear face of the zoom dial 13c side end of the camera head housing 13a. The housing 13a is connected to a distal end of the horizontal part 12c of the support column 12 by the bracket 13e, so that the housing 13a extends horizontally so as to be perpendicular to the horizontal part 12c of the support column 12 and is located ahead above the front of the base 11. A balancer (not shown) with a predetermined weight is provided in the base 11 in order that the visual presenter 10 may be prevented from falling ahead of the base 11 by the weight of the camera head 13.

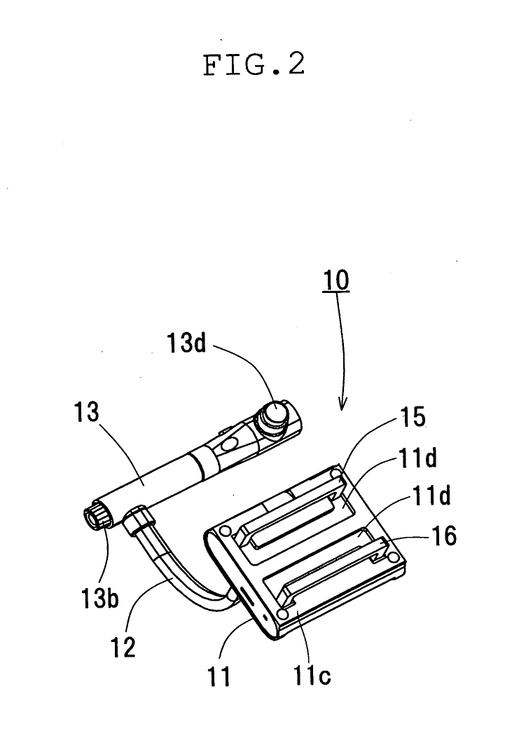

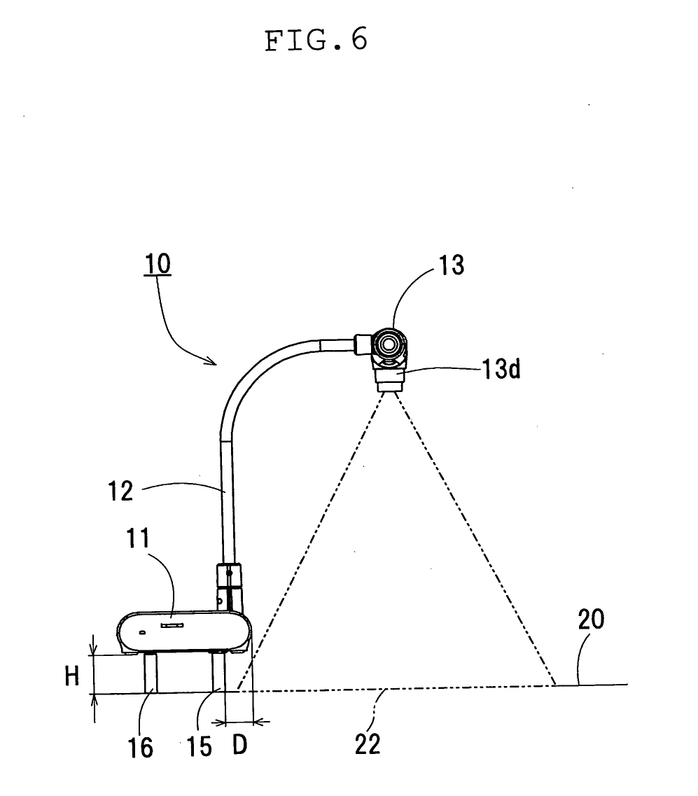

A front leg 15 and a rear leg 16 are mounted on the underside 11c of the base 11. In particular, the front leg 15 is located so as to be spaced rearward from the front 11a of the base 11 by a predetermined distance D (see FIG. 6). The front leg 15 includes a pair of longitudinal frames 15a and a transverse frame 15b connecting between the longitudinal frames 15a. The rear leg 16 also includes a pair of longitudinal frames 16a and a transverse frame 16b connecting between the longitudinal frames 16a. Each of the legs 15 and 16 is formed into an inverted portal shape and mounted so as to be pivotable between a raised state where each leg hangs down from the underside 11c of the base 11 and a laid state where each leg is laid on the underside 11c of the base 11. The underside 11c of the base 11 has two storage recesses 11d in which the legs 15 and 16 are stored when having been caused to fall thereby to be laid thereon, respectively, as shown in FIG. 2. The legs 15 and 16 are sized so that end faces of the legs 15 and 16 and the underside 11c of the base 11 are coplanar or the end faces of the legs 15 and 16 are located inside the underside 11c.

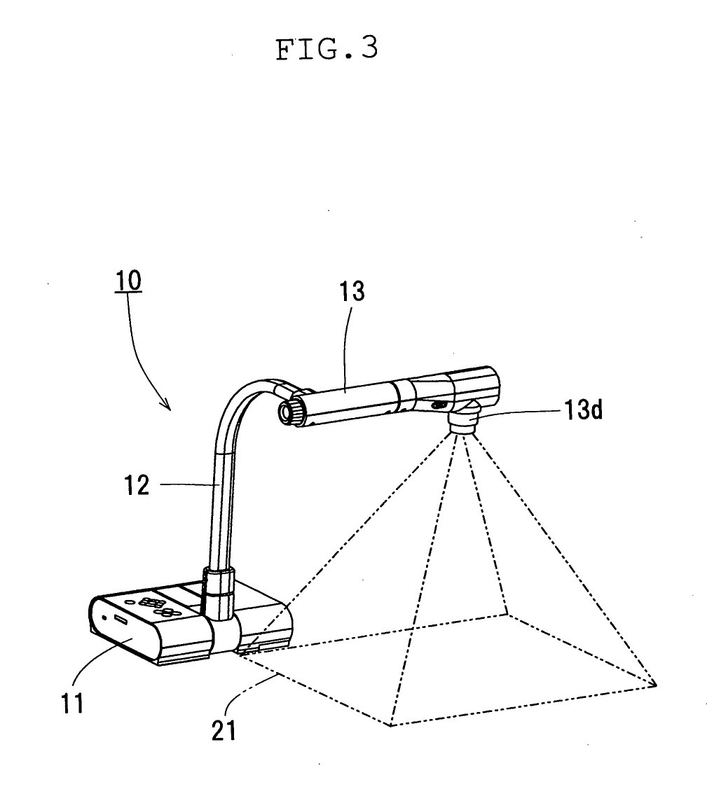

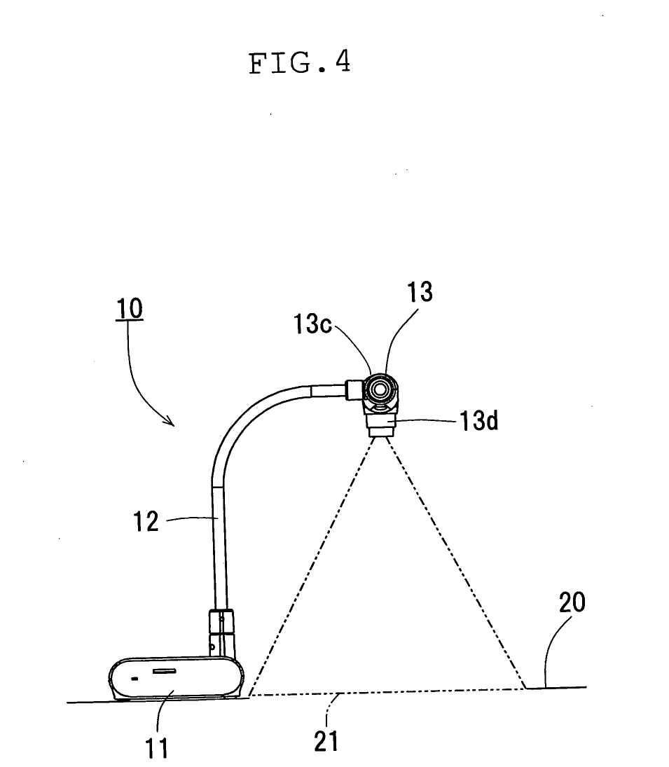

A usage of the visual presenter 10 as constructed above will now be described as follows. When the visual presenter 10 is to be used with the legs 15 and 16 being stored in the respective storage recesses 11d of the base 11, a material or document is placed on an installation surface 20, and the zoom dial 13c is operated so that an imaging area 21 on an installation surface (see FIG. 4) is adjusted in accordance with the size and position of the material, as shown in FIGS. 3 to 5. The legs 15 and 16 are raised from the respective storage recesses so as to hang down from the underside 11c when the size of the material is so large that the entire material cannot be imaged even when a field angle of the imaging lens is set to a widest angle, as shown in FIGS. 1, 2, 6 and 7. As a result, the distance from the installation surface 20 to the imaging lens set to widest is rendered longer by a height H (see FIG. 6) of the legs 15 and 16. Accordingly, an imaging area 22 on the installation surface 20 is enlarged so as to cover an area immediately before an installation point of the front leg 15.

According to the foregoing embodiment, the height H of the legs 15 and 16 and the setback distance D are set so that the imaging area 22 on the installation surface 20 is enlarged so as to cover the area immediately before the installation point of the front leg 15. Consequently, a material with a larger size can be imaged by the visual presenter 10, and the front leg 15 can be prevented from being imaged together with the larger material in the imaging of the material.

Furthermore, since the front and rear legs 15 and 16 are caused to fall thereby to be stored in the respective storage recesses 11d, the visual presenter 10 can be folded into a compact size.

The foregoing description and drawings are merely illustrative of the principles and are not to be construed in a limiting sense. Various changes and modifications will become apparent to those of ordinary skill in the art. All such changes and modifications are seen to fall within the scope as defined by the appended claims.

What is claimed is:

1. A visual presenter comprising:
a base;
a column support standing on the base and having a distal end on which a camera head is located, the column support including an upright part standing upright from the base and a horizontal part that is continuous from the upright part and extends horizontally ahead of the base, the distal end of the column support corresponding to a distal end of the horizontal part, the camera head being mounted on the distal end of the horizontal part and adapted to image a material placed on an installation surface for the presenter; and
a plurality of legs which are mounted on an underside of the base so that one of the legs is located at a predetermined position spaced backward from a front of the base by a predetermined distance, the legs extending in a direction perpendicular to the underside of the base so that an imaging area of the camera head on the installation surface is enlarged so as to cover an area immediately before an installation point of said one leg.

2. The visual presenter according to claim 1, wherein each leg is pivotable between a raised state where the leg hangs down from the underside of the base and a laid state where the leg is laid on the underside of the base.

3. The visual presenter according to claim 2, wherein the underside of the base has a plurality of storage recesses in which the legs are stored in the laid state respectively.
